(19) United States
(12) Patent Application Publication
(10) Pub. No.: US 2003/0036372 A1
(43) Pub. Date: Feb. 20, 2003

(54) Method of using bipolar junction transistor as self-oscillating down converter of a satellite down converter

(76) Inventor: Mao-Jen Chen, Chung-Li City (TW)

Correspondence Address: DOUGHERTY & TROXELL, Suite 1404, 5205 Leesburg Pike, Falls Church, VA, 22041, US

(21) Appl. No.: 09/928,420

(22) Filed: Aug. 14, 2001

(51) Int. Cl. H04B 1/28

(52) U.S. Cl. 455/333; 455/313; 455/323

(57) ABSTRACT

In a method of using a bipolar junction transistor as a self-oscillating down converter of a satellite down converter, a bipolar junction transistor substitutes for a mixer and a local oscillator in a signal processing circuit to achieve the same effect while the circuit is simplified. Therefore, the circuit is less complicate and may have reduced circuit area, enabling the satellite down converter to be manufactured at lower cost and in reduced dimensions.

### FIELD OF THE INVENTION

The present invention relates to a method of using a bipolar junction transistor as a self-oscillating down converter of a satellite down converter, and more particularly to a method of using a bipolar junction transistor as a self-oscillating down converter of a satellite down converter in which a bipolar junction transistor is used to replace mixer and local oscillator in a signal processing circuit, so that the same effect could be obtained with simplified circuit and at reduced manufacturing cost, and that a miniaturized product could be obtained due to reduced complexity of circuit and reduced circuit area.

### BACKGROUND OF THE INVENTION

With the quick and prosperous development in the communication industry, there are more and more occasions in which a satellite is utilized to transmit signals. To receive and process signals transmitted through the satellite, it is necessary to set up receiving horn antenna and satellite down converter on the ground.

FIG. 1 shows a part of the circuit for a conventional satellite down converter. The conventional satellite down converter includes a receiver 10 and an output port (not shown). A low-noise amplifier 11 and an intermediate frequency (IF) amplifier 12 are provided between the receiver 10 and the output port, a mixer 13 is serially connected between the two amplifiers 11, 12, and a field effect transistor (MESFET) 14 is further connected to the mixer 13 to enable reduction of frequency. A signal received from a satellite is processed through the low-noise amplifier 11, the mixer 13, the field effect transistor 14, and the IF amplifier 12 and then output to a desired apparatus to complete the transmission of the signal.

The above-described down converter has the following disadvantages:

1. The provision of the mixer and the local oscillator at the same time makes the circuit more complicate and including more components that would increase the manufacturing cost of the down converter and the area of the circuit board thereof to cause inconvenience in use.

2. If the mixer and the local oscillator are separately manufactured and setup, there is an adverse influence on the rate of good yield of the down converter. That is, the number of defective products and discarded components would increase that in turn increases the manufacturing cost of the down converter.

In view of the above-mentioned drawbacks existing in the conventional satellite down converter, it is tried by the inventor to develop a method to eliminate such drawbacks.

### SUMMARY OF THE INVENTION

It is a primary object of the present invention to provide a self -oscillating down converter that includes fewer components to simplify a circuit thereof and therefore enables reduced circuit area, reduced manufacturing cost, and increased rate of good yield in production of the down converter.

To achieve the above and other objects, the present invention provides a method of using a bipolar junction transistor as a self-oscillating down converter of a satellite down converter. The satellite down converter includes a circuit having at least a receiver and an output port. In the method of the present invention, a bipolar junction transistor is provided between a low-noise amplifier and an intermediate frequency amplifier that are located between the receiver and the output port, such that the bipolar junction transistor substitutes for the conventional mixer and the conventional local oscillator to serve as a local oscillator and a self-oscillating down converter. In this manner, the circuit of the satellite down converter is simplified to have reduced number of components and reduced circuit area.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic circuit diagram of a conventional satellite down converter; and

FIG. 2 is a schematic circuit diagram of a satellite down converter structured according to the method of the present invention, in which a bipolar junction transistor is used as a self-oscillating down converter.

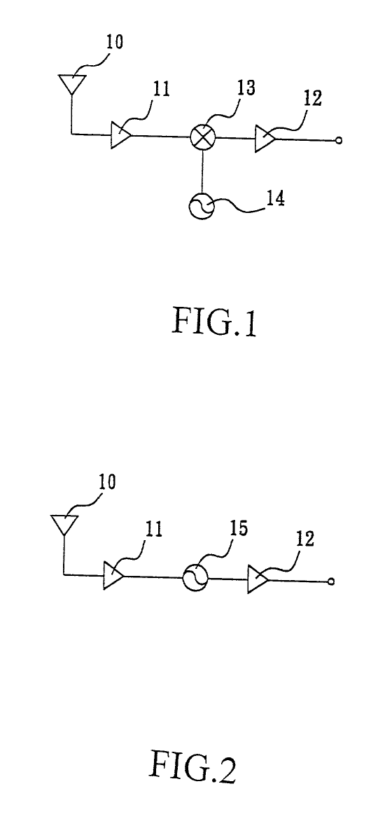

### DETAILED DESCRIPTION OF THE PREFERRED EMBODIMENTS

Please refer to FIG. 2 in which a schematic circuit diagram of a satellite down converter structured according to the method of the present invention is shown. As shown, a basic circuit of the satellite down converter includes a receiver 10 and an output port (not shown). In the method of the present invention, a bipolar junction transistor 15 is provided between a low-noise amplifier 11 and an IF amplifier 12 that are located between the receiver 10 and the output port of the satellite down converter, so that the bipolar junction transistor 15 substitutes for the conventional mixer 13 and the conventional local oscillator 14 known in the art. With the method of the present invention, the number of components needed in the circuit of a satellite down converter is reduced to enable lowered manufacturing cost and improved rate of good yield in the production of the satellite down converter. The present invention is therefore industrially practical for use.

The satellite down converter having a circuit structured according to the method of the present invention has reduced number of components and reduced area of circuit board thereof while it provides the same effect as that could be provided by the conventional satellite down converter. That is, the present invention provides a method of using bipolar junction transistor as the self-oscillating down converter of a satellite down converter that simplifies the structure and lowers the manufacturing cost of the satellite down converter to provide industrial advantages.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method of using a bipolar junction transistor as a self-oscillating down converter of a satellite down converter, said satellite down converter including a circuit having at least a receiver and an output port, said method comprising providing a bipolar junction transistor between a low-noise amplifier and an intermediate frequency amplifier included in said circuit, such that said bipolar junction transistor serves a local oscillator and a mixer.
